(19) United States
(12) Patent Application Publication
(10) Pub. No.: US 2003/0223776 A1
(43) Pub. Date: Dec. 4, 2003

(54) Developer cartridge and image forming apparatus

(75) Inventors: Yasuyuki Kato, Tokyo (JP); Junichi Ito, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Oki Data Corporation

(21) Appl. No.: 10/446,231

(22) Filed: May 27, 2003

(30) Foreign Application Priority Data
May 28, 2002 (JP) 2002-153482

(51) Int. Cl. G03G 15/08

(52) U.S. Cl. 399/120

(57) ABSTRACT

A developer cartridge has a first chamber that holds fresh toner and a waste toner chamber that holds waste toner. The toner cartridge includes a partition that divides an inner space of the toner cartridge into the fresh toner chamber and the waste toner chamber. The partition is such that the fresh toner chamber and the waste toner chamber extend substantially in parallel with each other and are partially adjacent to each other horizontally. The partition operates in such a way that the fresh toner chamber decreases in volume and the waste toner chamber increases in volume with increasing amount of the waste toner in the waste toner chamber. The movable portion may be a deformable bag-shaped member. The fresh toner chamber may have a resilient flap therein to agitate the fresh toner.

### BACKGROUND OF THE INVENTION

1. Field of the Invention

The present invention generally relates to a developer cartridge and an image forming apparatus.

2. Description of the Related Art

An image forming apparatus performs processes of charging, exposing, developing, transferring and fixing in sequence to record an image. The image forming apparatus includes a print process cartridge, which in turn includes a charging unit, a photoconductive drum, and a developing unit. A toner cartridge is detachably received in the print process cartridge and supplies toner to the developing unit. The charging unit charges the surface of the photoconductive drum uniformly. An exposing unit illuminates the charged surface of the photoconductive drum in accordance with print data to form an electrostatic latent image. The developing unit supplies toner to the electrostatic latent image to develop the latent image into a toner image. The toner image is transferred onto print paper by a transferring unit. Then, the print paper advances to a fixing unit where the toner image is fused into a permanent image. Toner that remains on the photoconductive drum after transfer is removed form the photoconductive drum and collected into a waste toner tank provided in the print process cartridge. However, the provision of a waste toner tank requires a space for housing the waste toner tank, leading to a large overall size of apparatus. Thus, a system is usually employed which collects residual toner into a toner cartridge so that the residual toner can be discarded together with the toner cartridge when the fresh toner in the toner cartridge has been exhausted.

However, a conventional toner cartridge requires a space that holds residual toner collected. This in turn reduces a space for holding fresh toner. As a result, when the toner cartridge is replaced, an amount of toner that can be replenished is small. This increases the cost of the toner cartridge per a predetermined number of printed pages. If a toner holding space is to be made larger, the overall size of the toner cartridge becomes large, leading to a larger overall size of an image forming apparatus.

### SUMMARY OF THE INVENTION

An object of the present invention is to provide a toner cartridge in which the replacement of the toner cartridge allows replenishment of as large an amount of fresh toner as possible and saving of the running cost of the image forming apparatus.

An object of the invention is to provide a toner cartridge that makes it possible to miniaturize an image forming apparatus.

A developer cartridge has a first chamber that holds fresh developer and a second chamber that holds waste developer. The cartridge includes a partition provided in the developer cartridge to divide an inner space of the developer cartridge into the first chamber and the second chamber. The partition operates in such a way that a volume of the second chamber increases in accordance with an amount of the waste developer in the second chamber.

The partition is such that the first chamber and the second chamber extend substantially in parallel with each other and are partially adjacent to each other horizontally.

The partition operates in such a way that the first chamber decreases in volume and the second chamber increases in volume.

The partition has a movable portion and a fixed portion that supports the movable portion. The second chamber has a waste developer inlet through which the second chamber receives the waste developer, the inlet being located under the movable portion.

The movable portion is a deformable bag-shaped member.

The bag-shaped member has a thickness in the range of 0.2 to 0.4 mm.

The second chamber has a swingable member therein. The swingable member is urged against the partition in such a way that the swingable member pushes the deformable bag-shaped member toward the first chamber.

The partition is detachably inserted into the developer cartridge.

The first chamber has a resilient flap extending in the first chamber.

The first chamber has an agitator bar that agitates the fresh toner in the first toner chamber. The resilient flap is a film. When the agitator bar agitates the fresh toner, the film moves into engagement with the agitator bar such that the film flexes and subsequently moves out of engagement with the agitator bar.

The second chamber extends in a longitudinal direction and has a first transport member therein that extends in the longitudinal direction of the second chamber and a waste developer inlet located at one of opposing ends of the second chamber. The first transport member transports the waste developer from the one of the opposing ends of the second chamber to another one of the opposing ends.

The first transport member has a spiral vane formed on it, the spiral vane extending from one end of the first transport member to a part of the first transport member.

The second chamber includes a second transport member therein for transporting the waste developer toward the waste toner inlet, the second transporting member extending above the first transport member in the longitudinal direction of the second chamber.

The partition operates to increase the second chamber in volume when the amount of waste toner exceeds a certain value.

An image forming apparatus has a developer cartridge that includes a first chamber that holds fresh developer and a second chamber that holds waste developer. The developer cartridge includes a partition provided in the cartridge to divide an inner space into the first chamber and the second chamber. The partition operates in such away that a volume of the second chamber increases in accordance with an amount of the waste developer in the second chamber.

The partition has a movable portion and a fixed portion that supports the movable portion. The second chamber has a waste developer inlet through which the second chamber receives the waste developer, the waste developer inlet being located under the movable portion.

The movable portion is a deformable bag-shaped member.

The bag-shaped member has a thickness in the range of 0.2 to 0.4 mm.

The second chamber has a swingable member therein, the swingable member being urged against the partition in such away that the swingable member pushes the deformable bag-shaped member.

The partition is detachably inserted into the developer cartridge.

The first chamber has a resilient flap extending in the first chamber.

The first chamber has an agitator bar that agitates the fresh toner in the first toner chamber. The resilient flap is a film, wherein when the agitator bar agitates the fresh toner, the film moves into engagement with the agitator bar such that the film flexes, and subsequently moves out of engagement with the agitator bar.

The second chamber extends in a longitudinal direction and has a first transport member therein that extends in the longitudinal direction of the second chamber and a waste developer inlet located at one of opposing ends of the second chamber. The first transport member transports the waste developer from the one of the opposing ends of the second chamber to another one of the opposing ends.

The first transport member has a spiral vane formed on it, the spiral vane extending from one end of the first transport member to a part of the first transport member.

The second chamber includes a second transport member therein for transporting the waste developer toward the waste developer inlet, the second transporting member extending above the first transport member in the longitudinal direction of the second chamber.

The partition operates in such a way that the first chamber increases in volume and the second chamber increases in volume.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 is a cross-sectional view, illustrating a general configuration of a color electrophotographic recording apparatus according to the invention;

FIG. 2 is a perspective view of a toner cartridge according to a first embodiment;

FIG. 3 is a cross-sectional view of the toner cartridge when it remains sealed;

FIG. 4 is a cross-sectional view of a cartridge that has reached the end of its lifetime;

FIG. 5 is a perspective view, illustrating a movable partitioning mechanism having a bag-shaped deformable partition;

FIG. 6 is a perspective view of the toner cartridge according to the second embodiment;

FIG. 7 is a cross-sectional view of the toner cartridge when it remains sealed;

FIG. 8 is a cross-sectional view of the toner cartridge when it is empty of fresh toner;

FIG. 9 is a perspective view of a movable partitioning mechanism having a bag-shaped deformable partition;

FIG. 10 is across-sectional side view, illustrating the interior of a toner cartridge according to the second embodiment;

FIG. 11 is a cross-sectional view, illustrating the waste toner held in the waste toner chamber of the toner cartridge according to the second embodiment;

FIG. 12 is a perspective view, illustrating the general configuration of a toner cartridge according to a third embodiment;

FIG. 13A is a cross-sectional view, illustrating the toner cartridge according to the third embodiment;

FIG. 13B is a fragmentary side view of a film and a bag-shaped deformable partition;

FIGS. 14 and 15 are expanded perspective views, illustrating the detail of a movable partitioning mechanism in FIG. 12;

FIG. 16 is a perspective view of the film assembled into the movable partitioning mechanism;

FIG. 17 is a perspective view, illustrating the deformable partition provided to the movable partitioning mechanism;

FIG. 18 is a perspective view of a side wall when the toner cartridge 9 is seen from outside of the toner cartridge;

FIG. 19 is a perspective view of the side wall when the toner cartridge is seen in a direction shown by arrow Q in FIG. 18;

FIG. 20 is a side view when the side wall is seen from a direction shown by arrow R in FIG. 19;

FIG. 21 illustrates the opening 37 when it is closed by the opening/closing member 28a; and

FIG. 22 illustrates the opening 37 when it is opened.

### DESCRIPTION OF THE INVENTION

Preferred embodiments of an electrophotographic printer according to the invention will be described.

First Embodiment

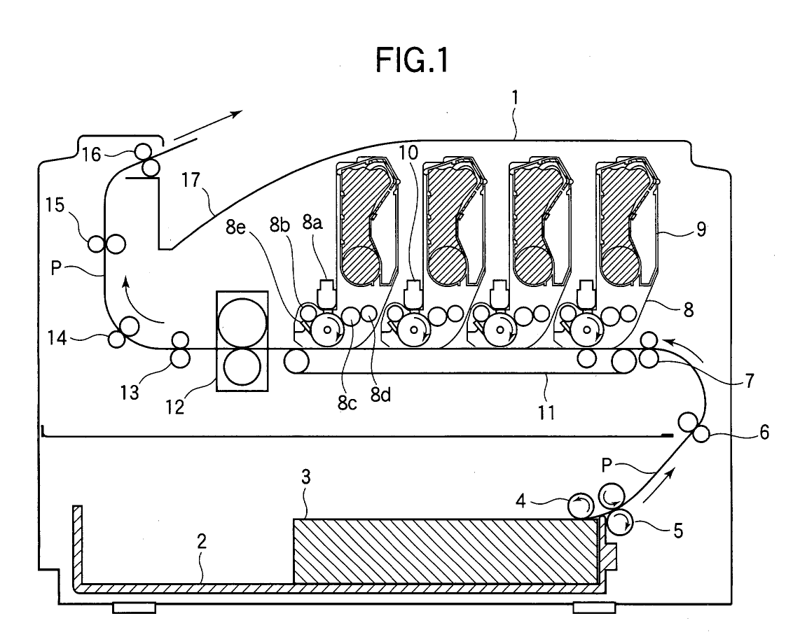

FIG. 1 is a cross-sectional view, illustrating a general configuration of a color electrophotographic recording apparatus according to the invention. Referring to FIG. 1, a paper cassette 2 holds print paper 3 therein. A roller 4 feeds the print paper 3 into a transport path P from the paper cassette 2 on a page-by-page basis. Transport rollers 5, 6, and 7 transport the print paper 3 to print process cartridges 8. The print paper 3 advances to a transfer section of the print process cartridge where the toner image is transferred onto the print paper 3. Then, the print paper 3 advances to a fixing unit 12 and then discharging roller 13, 14, 15 and 16 drive the print paper 3 into a paper stacker 17.

Four print process cartridges 8 are disposed along the transport path P of the print paper. The four print process cartridges 8 are of the same configuration and each of the four process cartridges 8 forms a toner image of a corresponding color. Each print process cartridge 8 includes a photoconductive drum 8a, a charging roller 8b, a developing roller 8c, a toner supplying roller 8d, a toner cartridge 9, and a cleaning unit 8e. The photoconductive drum 8a is a photoconductive body driven in rotation by a drum motor, not shown. The charging roller 8b charges the surface of the photoconductive drum 8a. The exposing unit 10 illuminates the charged surface of the photoconductive drum 8a to form an electrostatic latent image. The toner cartridge 9 supplies toner to the developing unit. The toner supplying roller 8d in the developing unit supplies toner to the developing roller 8c, which in turn supplies the toner to the electrostatic latent image to develop the electrostatic latent image into a toner image. The cleaning unit 8e scrapes the toner off the photoconductive drum 8a to clean the photoconductive drum 8a. The transfer unit 11 has transfer rollers that face corresponding photoconductive drums 8a to define transfer points between the photoconductive drums and the transfer rollers. When the print paper 3 passes each transfer point, a toner image of a corresponding color is transferred from the photoconductive drum onto the print paper 3.

With electrophotographic recording apparatus, some of the toner remains on the surface of the photoconductive drum 8a after transfer. The residual toner on the photoconductive drum 8a is removed by the cleaning unit 8e and is collected into a waste toner chamber of the toner cartridge 9.

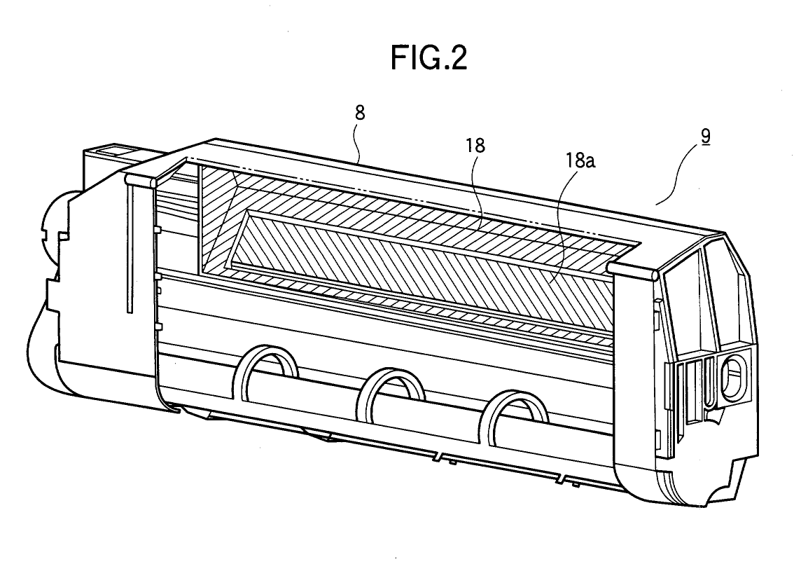

FIG. 2 is a perspective view of a toner cartridge according to a first embodiment.

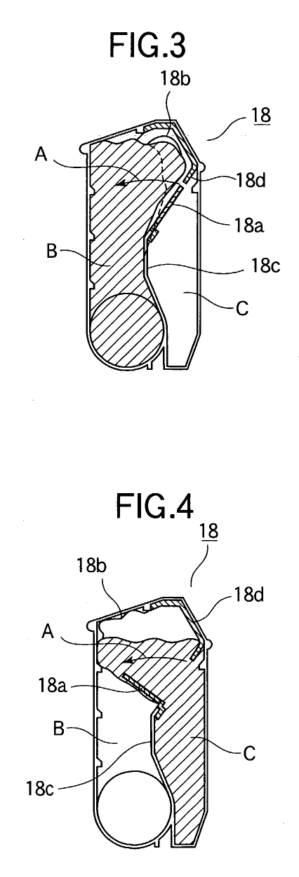

FIG. 3 is a cross-sectional view of the toner cartridge when it remains sealed.

FIG. 4 is a cross-sectional view of a cartridge that has reached the end of its lifetime.

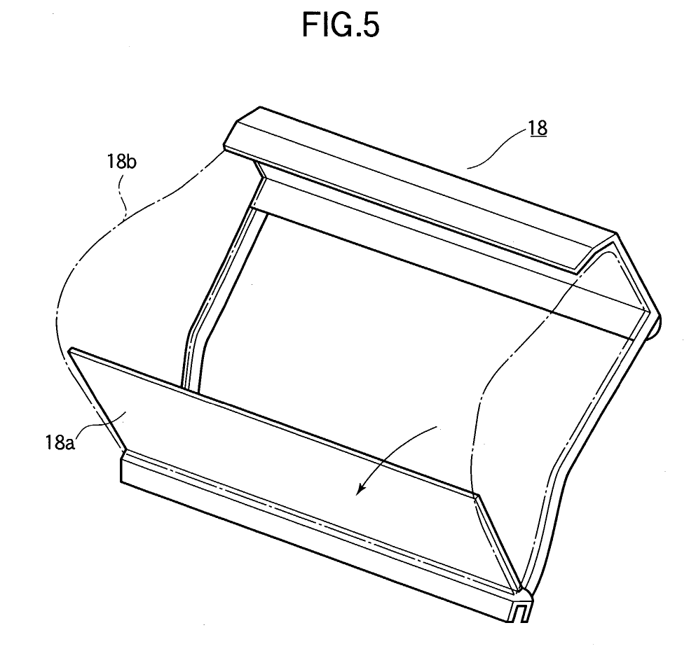

FIG. 5 is a perspective view, illustrating a movable partitioning mechanism having a bag-shaped deformable partition.

The toner cartridge 9 according to the embodiment will be described with reference to FIGS. 2-5. The toner cartridge 9 has a movable partitioning mechanism 18 that includes a swingable plate 18a, a bag-shaped deformable partition 18b, an upper partition 18d, and a lower partition 18c. The movable partitioning mechanism 18 divides an inner space of the toner cartridge 9 into a fresh toner chamber B and a waste toner chamber C.

A deformable partition 18b is disposed between the lower partitioning wall 18c near a swingable plate 18a and an upper portion of the upper partitioning wall 18d. The deformable partition 18b is fixed at its one end portion to the upper end of the upper partitioning wall 18d and at its other end to the upper end of the lower partitioning wall 18c. Thus, the flexible partition 18b defines the fresh toner chamber B and the waste toner chamber C that are sealed against each other, preventing the toner in the fresh toner chamber B form being mixed with the toner in the waste toner chamber C. The swingable plate 18a is pivotally mounted to the upper end of the lower partitioning wall 18c. As shown in FIG. 3, a spring, not shown, urges the swingable plate 18a in a direction shown by arrow A.

As printing is performed repeatedly, the fresh toner in the fresh toner chamber B decreases gradually. The residual toner on the photoconductive drum 8a is removed from the photoconductive drum 8a and collected into the waste toner chamber C by a toner collecting mechanism provided on a die frame, not shown. As the fresh toner decreases, the swingable plate 18a will be inclined gradually by the spring, not shown, in the direction shown by arrow A as shown in FIG. 3. As a result, the waste toner chamber C increases in volume.

The first embodiment has been describe with respect to a case in which the waste toner chamber C gradually increases in volume as the amount of waste toner collected in the chamber C increases. A modification can be made such that when the amount of waste toner exceeds a certain value, the urging force of the spring is large enough to allow the swingable plate 18a to swing. The modification allows the volume of the waste toner chamber C to increase when no fresh toner is present in the fresh toner chamber B, preventing toner clump in the waste toner chamber C.

Second Embodiment

A second embodiment differs from the first embodiment in the interior structure of the toner cartridge.

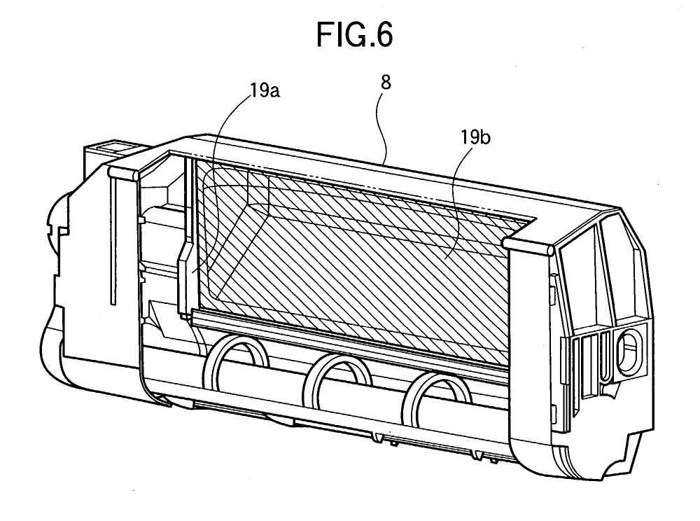

FIG. 6 is a perspective view of the toner cartridge according to the second embodiment.

FIG. 7 is a cross-sectional view of the toner cartridge when it remains sealed.

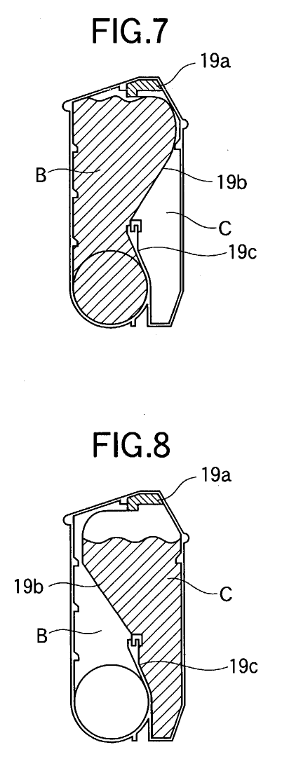

FIG. 8 is a cross-sectional view of the toner cartridge when it is empty of fresh toner.

FIG. 9 is a perspective view of a movable partitioning mechanism having a bag-shaped deformable partition.

As shown in FIGS. 6-8 and 9, the toner cartridge has a lower partitioning wall 40c, an upper partitioning wall 19a, and a bag-shaped deformable partition 19b that defines the toner chamber B and the waste toner chamber C. The bag-shaped deformable partition 19b, upper partitioning wall 19a, and lower partitioning wall 40c are integral with one another so that a small force can cause the bag-shaped deformable partition 19b to displace toward the fresh toner chamber B or toward the waste toner chamber C.

When printing is performed repeatedly, the fresh toner in the fresh toner chamber B decreases gradually. The residual toner is removed from the photoconductive drum, and is collected by the toner collecting mechanism into the waste toner chamber C. The waste toner collected into the waste toner chamber C is moved by a later described spiral shaft from near end to the far end in the waste toner chamber C. The waste toner is gathered toward the middle of the waste toner chamber C and applies pressure against the deformable partition 19b, so that the bag-shaped partitioning 19b is pushed by the waste toner toward the fresh toner chamber. Thus, the waste toner chamber C increases in volume by an amount of the movement of the deformable partition 19b.

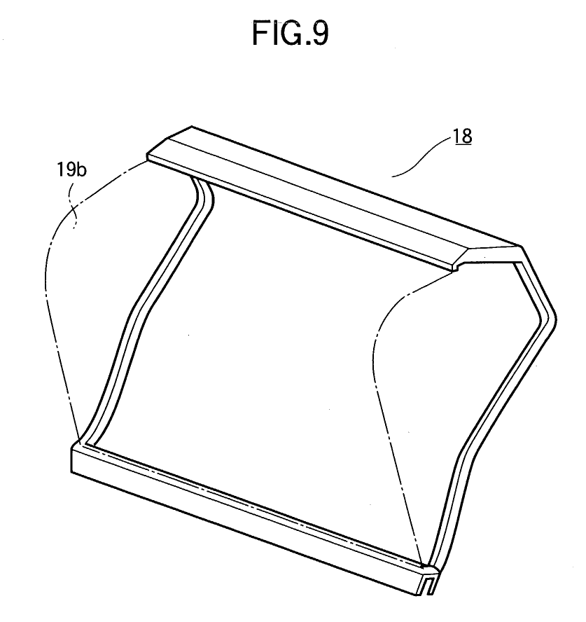

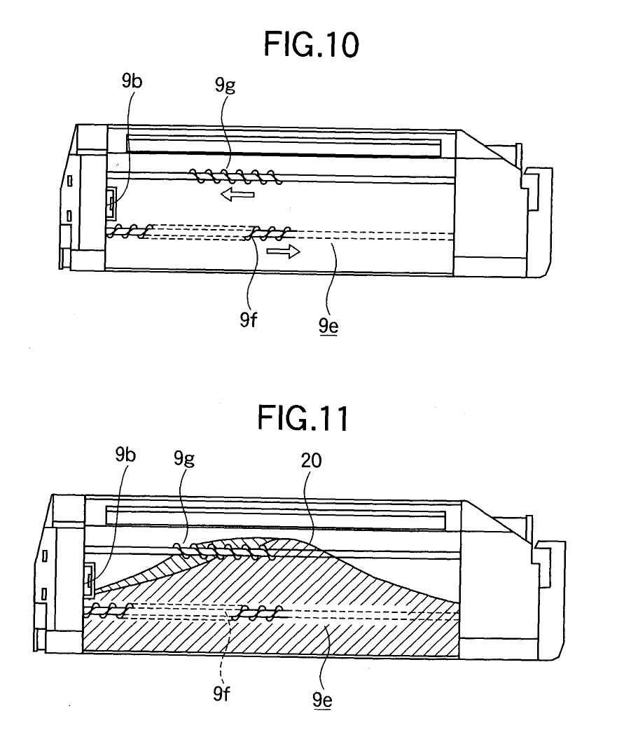

FIG. 10 is across-sectional side view, illustrating the interior of a toner cartridge according to the second embodiment.

FIG. 11 is a cross-sectional view, illustrating the waste toner held in the waste toner chamber of the toner cartridge according to the second embodiment.

For efficient utilization of the space in the waste toner chamber, the spiral shaft 9e is rotated to move the pile of toner 20 toward the middle of the waste toner chamber C. A conventional spiral shaft has a vane 9f that spans across the entire length of the spiral shaft 9e so as to move the waste toner to the end of waste toner chamber C. The spiral shaft 9e according to the second embodiment has the vane 9f shaft so that the bag-shaped deformable partition 19b efficiently deforms into the adjacent chamber. There is provided a spiral shaft 9g over the spiral shaft 9e and these two shafts rotate. The spiral shaft 9g has a vane that describes a spiral in the opposite direction to the spiral shaft 9e, the vane causing the top of the pile of the waste toner 20 to fall toward an waste toner inlet 9b.

During printing, the toner in the fresh toner chamber B is used in developing and residual toner is removed from the photoconductive drum and collected by the toner collecting mechanism, not shown into the waste toner chamber C. The spiral shaft 9e causes the waste toner 20 in the waste toner chamber C to move to the end of the waste toner chamber C. Because the vane 9f extends only as far as the middle of shaft 9e, the waste toner 20 begins to pile up at a longitudinal middle of the bag and the pile will grow there. As a result, the waste toner will produce a pressure that causes the bag to extend toward the fresh toner chamber B easily and the pile of the waste toner 20 to fall toward a waste toner inlet 9b. Thus, the waste toner 20 is distributed all over the floor in the waste toner chamber C, allowing efficient use of the toner holding space.

The deformable partition 19b that defines the boundary between the fresh toner chamber B and the waste toner chamber C deforms substantially uniformly across the length of the waste toner chamber C, ensuring that a space holding the waste toner 20 is enlarged. Because the collected waste toner 20 is distributed all over floor in the waste toner chamber C, a limited small space can be efficiently utilized.

Third Embodiment

FIG. 12 is a perspective view, illustrating the general configuration of a toner cartridge according to a third embodiment.

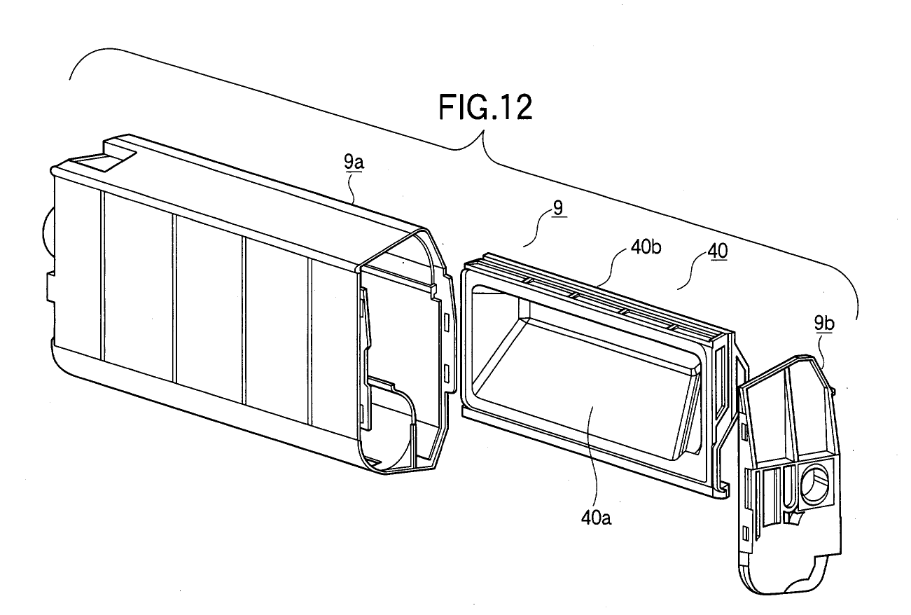

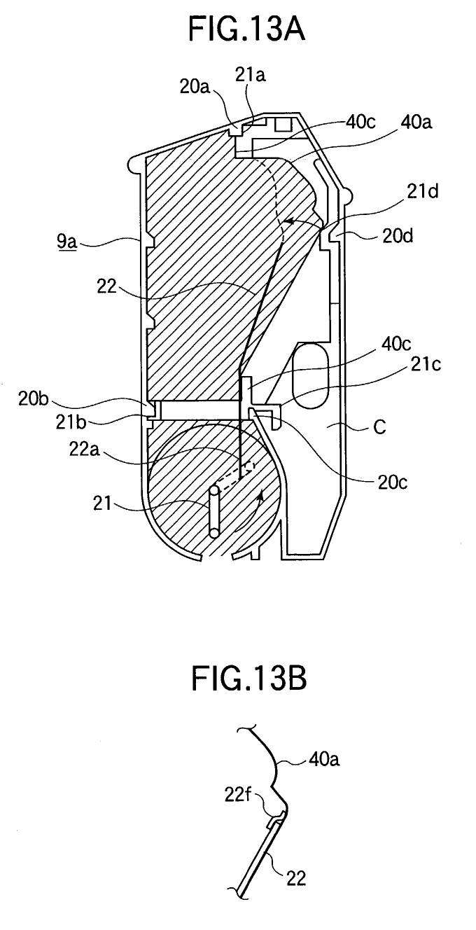

FIG. 13A is a cross-sectional view, illustrating the toner cartridge according to the third embodiment.

FIG. 13B is a fragmentary side view of a film and a bag-shaped deformable partition.

As shown in FIG. 12, the toner cartridge 9 includes an outer case 9a, a movable partitioning mechanism 40 slidably assembled into the outer case 9a, and a side wall 9b that closes the side of the outer case 9a. The movable partitioning mechanism 40 has a bag-shaped deformable partition 40a, which is assembled in a unitary construction. When the movable partitioning mechanism 40 is slidably assembled into the outer case 9a, the fresh toner chamber B and waste toner chamber C are defined in the outer case 9a a shown in FIG. 13A. It is to be noted that the movable partitioning mechanism 40 can disassembled from the outer case 9a so that the movable partitioning mechanism can be re-used by simply replacing a later described sealing member 24.

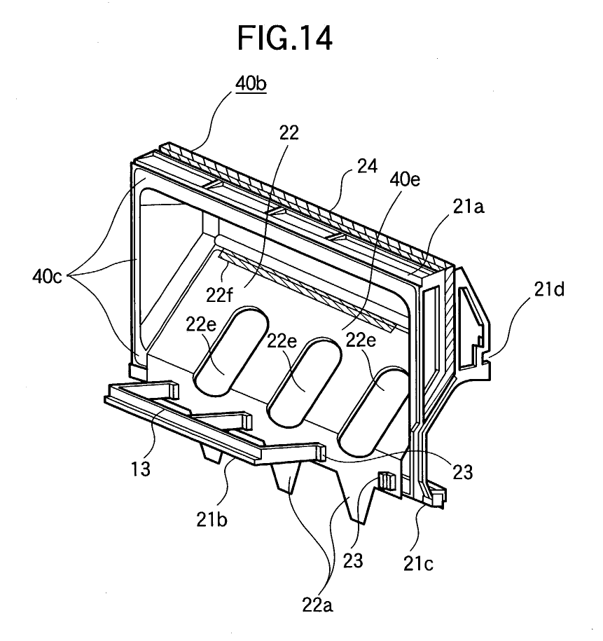

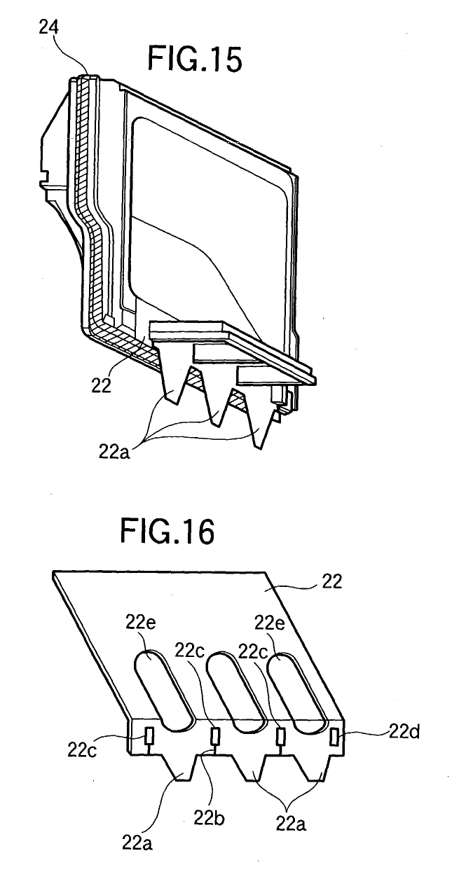

FIGS. 14 and 15 are expanded perspective views, illustrating the detail of a movable partitioning mechanism 40 in FIG. 12.

FIG. 16 is a perspective view of a film assembled into the movable partitioning mechanism 40.

FIG. 17 is a perspective view, illustrating the deformable partition provided to the movable partitioning mechanism.

The bag-shaped deformable partition 40a (FIG. 17) is inserted in a recess 40e formed in the movable partitioning mechanism 40. The outer peripheral portion 40d of the deformable partition 40a is welded to the end portion 40c of the frame 40b. The deformable partition 40a defines the fresh toner chamber B and the waste toner chamber C. The movable partitioning mechanism 40 also has a film 22 having its tip attached to the bag-shaped deformable partition 40a by means of a tape 22f as shown in FIG. 13B and FIG. 14. The film 22 is movable with the bag-shaped deformable partition 40a in the direction shown by an arrow. The material and thickness of the deformable partition 40a are selected such that the deformable partition 40a can easily deform into the adjacent chamber. The deformable partition 40a is vacuum-molded from a sheet of polyethylene or polypropylene by using a concave mold. The thickness t of the deformable partition 40a is in the range of 0.2 mm≦t≦0.4 mm.

If the thickness t is such that t≦0.2 mm, there may be a large variation of thickness, making it difficult to properly mold the deformable partition 40a. If the thickness t is in the relation that t≧0.4 mm, the bag loses flexibility significantly to such an extent that a small pressure applied by the waste toner 20 is not enough to cause the bag-shaped deformable partition 40a to deform. Therefore, a sufficient amount of waste toner cannot be collected.

As shown in FIGS. 14 and 15, the frame 40b has an outer end on which a sealing member (sponge) 24, shown by hatching. The sealing member 24 seals between the outer end and the outer case 9a when the movable partitioning mechanism 40 is inserted into the toner cartridge. The sealing member 24 isolates the fresh toner chamber B from the waste toner chamber C completely, so that the toners in the both chambers are not mixed with each other.

As shown in FIGS. 14 and 15, the frame 40b of the movable partitioning mechanism 40 has guides 21a-21d. As shown in FIG. 13, there are provided guides 20a-20d on the inner wall surface of the outer case 9a. When the outer case 9a is inserted into or pulled out of the outer case 9a, the aforementioned guides of the frame 40b engage the aforementioned guides of the outer case 9a, thereby allowing the outer case 9c to smoothly guide the frame 40b. Upon completion of insertion of the frame 40b, the frame 40b is accurately positioned in the outer case 9a.

The guides 21a-21d of the frame 40b serve to add mechanical strength to the frame 40b.

FIG. 17 illustrates the bag-shaped deformable partition 40a before it is attached to the movable partitioning mechanism 40. The deformable partition 40a has an outer peripheral portion bonded to the frame 40b by an adhesive. As shown in FIG. 16, the film 22 has, three large holes 22f, three slits 22b, three holes 22c, and one hole 22d, which are fitted to guides 23 of the frame 40b. The film 22 is disposed on the inside of the fresh toner chamber B.

The film 22 is detachably mounted at a portion near tips 22a for the reasons, which will be described later. As shown in FIG. 13, the tips 22 project into a rotational path of an agitator bar 21 to agitate the toner in the fresh toner in the chamber B. The film 22 is configured to the deformable partition 40a, i.e., the film 22 is bent as shown in FIGS. 15 and 16. As shown in FIG. 13, the agitator bar 21 rotates to engage the tips 22a, causing the tips 22a to flex. The agitator bar 21 further rotates to subsequently release the tips 22a, so that the film 22 vibrates lightly in its entirety. The film 22 is mounted to the movable partitioning mechanism 40 in such a way that it will not come off the frame 40b when the agitator bar 21 continues to rotates, cycling to move into and out of engagement with the tips 22a.

As shown in FIG. 13, the agitator bar 21 rotates in a direction shown by an arrow to agitate the toner, thereby supplying the toner to the developing unit, not shown, at all times. The film 22 is made of, for example, polyester and has a thickness t in the range of 0.05 mm≦t≦0.25 mm, and preferably t≦0.1 mm. A thickness t less than 0.05 mm cannot make the film 22 resilient enough to add vibration to the toner in the fresh toner chamber B when the tips 22a are released from the agitator bar 21. A thickness t greater than 0.25 mm makes the film too rigid, so that the pressure given by the waste toner is not large enough to cause the deformable partition 40a to deform toward the fresh toner chamber B. Thus, the waste toner chamber C cannot hold a large amount of waste toner.

Because the film 22 is detachably mounted to the frame 40b, the film 22 can be disassembled for cleaning.

The toner cartridge according to the third embodiment operates as follows: As printing is performed repeatedly, the fresh toner in the fresh toner chamber B is consumed gradually and the residual toner is removed from the photoconductive drum and collected into the waste toner chamber C. The waste toner 20 in the waste toner chamber C is moved further into the chamber C by the spiral shaft 9e (FIG. 10). Thus, the waste toner 20 will pile up with its top located in the middle of the longitudinally extending waste toner chamber C. The pile of the waste toner 20 produces pressure to push the deformable partition 40a toward the fresh toner chamber B. As the waste toner 20 increases, the bag-shaped deformable partition 40a will extend toward the fresh toner chamber B as shown in FIG. 17, so that a larger amount of waste toner 20 can be held in the waste toner chamber C.

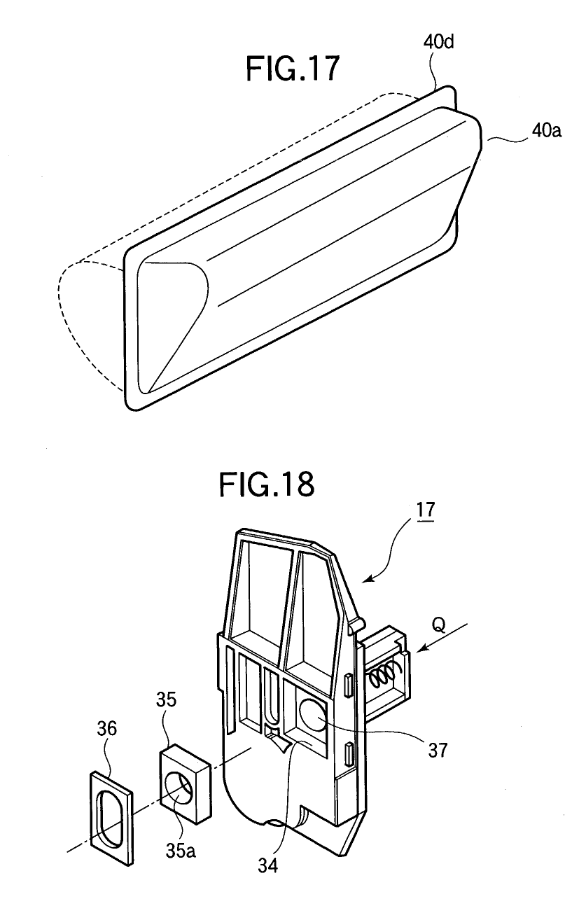

With the third embodiment, the opening, through which the waste toner is introduced into the waste toner chamber C, is located below a swelled portion of the bag-shaped deformable partition 40a. The deformable partition 40a is caused to extend toward the fresh toner chamber B after the waste toner piles up in the waste toner chamber C. This feature will be described in more detail with reference to FIGS. 18-22.

FIG. 18 is a perspective view of a side wall 17 when the toner cartridge 9 is seen from outside of the toner cartridge.

Referring to FIG. 18, there is provided a support 34 to surround an opening 37. The support 34 receives a resilient foaming sponge 35 having a thickness of several millimeters. An outer cover 36 is attached in the outer surface of the side wall 17, thereby preventing the foaming sponge 35 from disengaging from the side wall 17. The foaming sponge 35 has a hole 35a formed in the middle through which a toner discharging beak 42 enters into the waste toner chamber C through the opening 37. When the toner discharging beak 42 enters the opening 37, the foaming sponge 35 engages the toner discharging beak 42. This structure substantially eliminates the gap between the toner discharging beak 42 and the opening which would otherwise causes the toner spillage from the toner cartridge when the toner discharging beak 42 is pushed into the chamber C and pulled out of the chamber C.

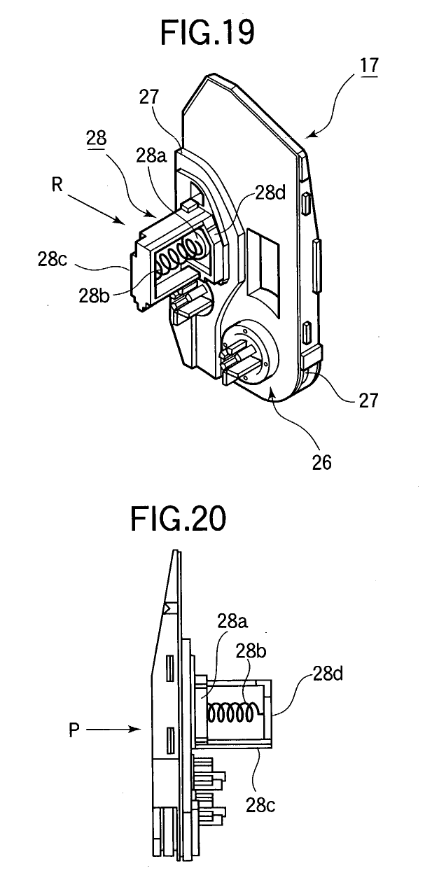

FIG. 19 is a perspective view of the side wall 17 when the toner cartridge is seen in a direction shown by arrow Q in FIG. 18. FIG. 19 illustrates the opening 37 closed by an opening/closing member 28a, i.e., when the toner-discharging beak 42 is not pushed into the toner cartridge.

As shown in FIG. 19, an inner plate 27 is fixed to the inner surface of the side wall 17 by means of fitting member, not shown. The inner plate 27 has an opening/closing mechanism 28 mounted thereto. The opening/closing mechanism 28 includes an opening/closing member 28a that closes the opening 37 from the inside of the toner cartridge, a frame 28c that movably holds the opening/closing member 28a, a spring 28b that urges the opening/closing member 28a outwardly, and a movable member 28d to which one end of the spring 28b is secured.

FIG. 20 is a side view when the sidewall 17 is seen from a direction shown by arrow R in FIG. 19.

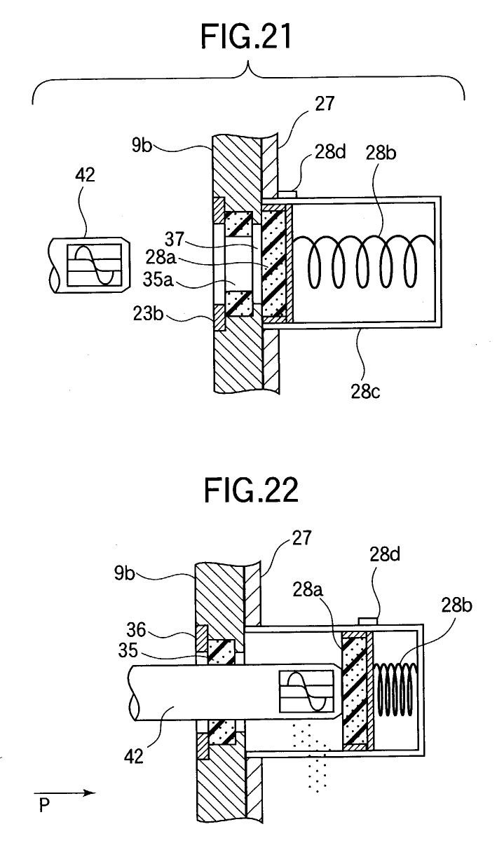

FIG. 21 illustrates the opening 37 when the opening/closing member 28a closes the opening 37.

FIG. 22 illustrates the opening 37 when it is opened.

As shown in FIG. 21, the opening 37 remains closed until the toner cartridge has been attached to the image forming apparatus. When the toner cartridge is attached to the image forming apparatus, the toner discharging beak 42 pushed the opening/closing member 28a in a direction shown by arrow P. The opening/closing member 28a moves along the slide against the urging force of the spring 28b, so that the toner transport path on the image forming apparatus communicates with the waste toner chamber C of the toner cartridge. The toner-discharging beak 42 enters the waste toner chamber C by a predetermined distance and is maintained where it is. This ensures that the residual toner delivered to the toner cartridge falls into the waste toner chamber C.

When the toner cartridge is detached from the image forming apparatus, the toner discharging beak 42 is withdrawn from the opening 37, so that the opening/closing member 28a is urged by the spring 28b to close the opening 37. Thus, the toner in the waste toner chamber C will not leak.

The opening 37 through which the waste toner chamber C receives the residual toner is located below the bag-shaped deformable partition 40a. Therefore, the waste toner chamber C can be disposed as close to the image forming section below the cartridge as possible. This configuration provides a shorter toner-transporting path, reducing the possibility of waste toner being clogged in the toner-transporting path.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developer cartridge having a first chamber that holds fresh developer and a second chamber that holds waste developer, comprising:
a partition provided in the developer cartridge to divide an inner space of the developer cartridge into the first chamber and the second chamber;
wherein said partition operates in such a way that a volume of the second chamber increases in accordance with an amount of the waste developer in the second chamber.

2. The developer cartridge according to claim 1, wherein said partition is such that the first chamber and the second chamber extend substantially in parallel with each other and are partially adjacent to each other horizontally.

3. The developer cartridge according to claim 1, wherein said partition operates in such a way that the first chamber decreases in volume and the second chamber increases in volume.

4. The developer cartridge according to claim 1, wherein said partition has a movable portion and a fixed portion that supports the movable portion,
wherein the second chamber has a waste developer inlet through which the second chamber receives the waste developer, the inlet being located under the movable portion.

5. The developer cartridge according to claim 4, wherein the movable portion is a deformable bag-shaped member.

6. The developer cartridge according to claim 5, wherein the bag-shaped member has a thickness in the range of 0.2 to 0.4 mm.

7. The developer cartridge according to claim 5, wherein the second chamber has a swingable member therein, the swingable member being urged against the partition in such a way that the swingable member pushes the deformable bag-shaped member toward the first chamber.

8. The developer cartridge according to claim 1, wherein the partition is detachably inserted into the developer cartridge.

9. The developer cartridge according to claim 1, wherein the first chamber has a resilient flap extending in the first chamber.

10. The developer cartridge according to claim 9, wherein the first chamber has an agitator bar that agitates the fresh developer in the first chamber,
wherein the resilient flap is a film, wherein when the agitator bar agitates the fresh developer, the film moves into engagement with the agitator bar such that the film flexes and subsequently moves out of engagement with the agitator bar.

11. The developer cartridge according to claim 1, wherein the second chamber extends in a longitudinal direction and has a first transport member therein that extends in the longitudinal direction of the second chamber and a waste developer inlet located at one of opposing ends of the second chamber,
wherein the first transport member transports the waste developer from the one of the opposing ends of the second chamber to another one of the opposing ends.

12. The developer cartridge according to claim 11, wherein the first transport member has a spiral vane formed on it, the spiral vane extending from one end of the first transport member to a part of the first transport member.

13. The developer cartridge according to claim 12, wherein the second chamber includes a second transport member therein for transporting the waste developer toward the waste developer inlet, the second transporting member extending above the first transport member in the longitudinal direction of the second chamber.

14. The developer cartridge according to claim 1, wherein said partition operates to increase the second chamber in volume when the amount of waste developer exceeds a certain value.

15. An image forming apparatus having a developer cartridge that includes a first chamber that holds fresh developer and a second chamber that holds waste developer, the developer cartridge comprising:
a partition provided in the cartridge to divide an inner space into the first chamber and the second chamber;
wherein said partition operates in such a way that a volume of the second chamber increases in accordance with an amount of the waste developer in the second chamber.

16. The image forming apparatus according to claim 15, wherein said partition has a movable portion and a fixed portion that supports the movable portion,
wherein the second chamber has a waste developer inlet through which the second chamber receives the waste developer, the waste developer inlet being located under the movable portion.

17. The image forming apparatus according to claim 16, wherein the movable portion is a deformable bag-shaped member.

18. The image forming apparatus according to claim 17, wherein the bag-shaped member has a thickness in the range of 0.2 to 0.4 mm.

19. The image forming apparatus according to claim 17, wherein the second chamber has a swingable member therein, the swingable member (18a) being urged against the partition in such away that the swingable member pushes the deformable bag-shaped member.

20. The image forming apparatus according to claim 15, wherein the partition is detachably inserted into the developer cartridge.

21. The image forming apparatus according to claim 15, wherein the first chamber has a resilient flap extending in the first chamber.

22. The image forming apparatus according to claim 15, wherein the first chamber has an agitator bar that agitates the fresh developer in the first chambe,
wherein the resilient flap is a film, wherein when the agitator bar agitates the fresh developer, the film moves into engagement with the agitator bar such that the film flexes, and subsequently moves out of engagement with the agitator bar.

23. The image forming apparatus according to claim 15, wherein the second chamber extends in a longitudinal direction and has a first transport member therein that extends in the longitudinal direction of the second chamber and a waste developer inlet located at one of opposing ends of the second chamber,
wherein the first transport member transports the waste developer from one of the opposing ends of the second chamber to another one of the opposing ends.

24. The image forming apparatus according to claim 23, wherein the first transport member has a spiral vane formed on it, the spiral vane extending from one end of the first transport member to a part of the first transport member.

25. The image forming apparatus according to claim 24, wherein the second chamber includes a second transport member therein for transporting the waste developer toward the waste developer inlet, the second transporting member extending above the first transport member in the longitudinal direction of the second chamber.

26. The image forming apparatus according to claim 15, wherein said partition operates in such a way that the first chamber decreases in volume and the second chamber increases in volume.
